(19) United States
(12) Patent Application Publication
(10) Pub. No.: US 2025/0268406 A1
(43) Pub. Date: Aug. 28, 2025

(54) Automated Assisted Feeding Device

(71) Applicant: Daniel Joseph Poirier, Dripping Springs, TX (US)

(72) Inventor: Daniel Joseph Poirier, Dripping Springs, TX (US)

(21) Appl. No.: 18/589,943

(22) Filed: Feb. 28, 2024

(51) Int. Cl. A47G 21/08; B25J 9/16; B25J 11/00

(52) U.S. Cl. CPC A47G 21/08; B25J 9/1612; B25J 11/008

(57) ABSTRACT

An automated feeding device product for helping hold and incrementally advance handheld food. This device may be portable and motorized, controlled by a processor that helps an eater be less reliant on their hands or an aid in order to hold and eat handheld foods. This device may include a pair of grips that cooperate at the eater's command.

### FIELD

The present application relates to a portable automated assisted feeding device that may help individuals who have limited use of their hands to eat handheld foods independently. This device may hold and advance the food on demand.

### BACKGROUND

Individuals with limited abilities to use their arms and hands due to stroke, loss of a limb, or a debilitating disease for example, require help feeding. For example, they may have difficulty raising a solid food such as a sandwich to their mouth with ease, or with enough precision. In addition, they may chew slowly, requiring an assistant to have to wait long periods of time between each bite. Therefore, there is a need for a device that holds and manages a handheld food in a regulated, reliable, and controlled manner. Individuals may be seated at a table, and or in a wheelchair, or in a bed. Therefore, there is a need for an automated assisted feeding device that can be portable and accommodate for a range of seating orientations and locations.

### NOTATION AND NOMENCLATURE

Certain terms are used throughout the following description and claims to refer to particular system components. As one skilled in the art will appreciate, companies that design and manufacture electrosurgical systems may refer to a component by different names. This document does not intend to distinguish between components that differ in name but not function.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection or through an indirect connection via other devices and connections.

Reference to a singular item includes the possibility that there are plural of the same items present. More specifically, as used herein and in the appended claims, the singular forms “a,” “an,” “said” and “the” include plural references unless the context clearly dictates otherwise. It is further noted that the claims may be drafted to exclude any optional element. As such, this statement serves as antecedent basis for use of such exclusive terminology as “solely,” “only” and the like in connection with the recitation of claim elements, or use of a “negative” limitation. Lastly, it is to be appreciated that unless defined otherwise, all technical and scientific terms used herein have the same meaning as commonly understood by one of ordinary skill in the art to which this invention belongs.

Where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

“Handheld food” shall mean a food that is typically held by an eater's hand and eaten over multiple bites, such as, but not limited to a sandwich, bread roll, calzone, pizza, burrito, hotdog, waffle, burger, donut, cake, chocolate bar or cookie. Handheld food may include multiple individual foods that are assembled, as is the case with a sandwich. Handheld food may include portions of an item such as a half sandwich or slice of pizza for example.

“Eater” shall mean the person eating the handheld food. Eater in the context of this disclosure may also be called a “user”.

“Assistant” or “Aid” in the context of this disclosure shall mean a person other than the eater, who may prepare the handheld food and load it into the device.

“Switch” shall mean any means of communicating an input to operate the feeding mechanism. A switch may include a physical button, puff switch, knob, slide or lever on the device in wireless, wired or mechanical communication the device. A switch may be operated by a body part, such as but not limited to a hand, foot, chin or head motion. A remote switch may include a keyboard key of a computer, or virtual button on a tablet App, the computer or tablet may be in wired or wireless communication with the device.

### SUMMARY

Disclosed herein is an assisted feeding device that may be portable and may grip and advance a handheld food in a safe and reliable manner. The device may incorporate compact motors and drives with a motion profile that is designed to regulate the forward progress of handheld foods for consumption. This invention may allow individuals, hereinafter “eaters”, who generally require feeding by others due to health issues, the freedom to feed themselves. Devices disclosed herein may use motors and gears to position custom interchangeable food grade materials, shaped to grip food. Devices disclosed herein may be collapsible for transport and adjustable to adapt feeding position to each individual's needs.

An example device embodiment is disclosed for holding and advancing a handheld food, by persons with limited or no use of their arms. The device may include a base, and a control housing for housing a controller operably coupled to a plurality of servos. The plurality of servos are operably coupled to a food handling mechanism including a pair of opposing arms. The controller my include a memory and processor and the memory may store a program that when executed by the processor, causes the processor to command the plurality of servos to control the pair of arms to hold and/or release and/or advance the handheld food. The food handling mechanism may be coupled to the base and or control housing. The pair of opposing arms may include a first side or first arm and a second side or second arm. The first side may include a first post coupled to a first servo such that it may angularly rotate about a first post axis upon actuation (via communication from the processor) of the first servo. The first side may also include a first tray coupled to the first post for supporting a first side of the handheld food. The first side may also include a first grip pivotally coupled to the first post. The first grip may be coupled to a second servo such that the first grip may move from a gripping position to an open position upon actuation (via communication from the processor) of the second servo. In the gripping position, the first grip engages the first side of the handheld food, and in the open position, the handheld food is slideable relative to the first grip. The second side may include a second post coupled to a third servo such that it may angularly rotate about a second post axis upon actuation (via communication from the processor) of the third servo. The second side may also include a second tray coupled to the second post for supporting a second side of the handheld food. The second side may also include a second grip pivotally coupled to the second post. The second grip may be coupled to a fourth servo such that the second grip may move from a gripping position to an open position upon actuation (via communication from the processor) of the fourth servo. In the gripping position, the second grip engages the second side of the handheld food, and in the open position, the handheld food is slideable relative to the second grip.

Upon receiving an input from a user to advance the food, the program executed by the processor, may cause the processor to command the plurality of servos to cause the first and second side of the food handling mechanism to move through a plurality of sequential steps to advance the food and then hold the food while the user eats. The plurality of sequential steps may include moving the first grip to the open position, and while the first grip is in the open position, rotating the second post so as to rotate the first side of the handheld food towards the user and then returning the first grip to the gripping position. The plurality of sequential steps may proceed to include moving the second grip to the open position after returning the first grip to the gripping position, and while the second grip is in the open position, rotating the first post to rotate the second side of the handheld food towards the user and then returning the second grip to the gripping position, such that both grips are in the gripping position.

While the second grip is in the opening position and the first post is rotating, the processor may also command the fourth servo to rotate the second post. The second post may rotate an equivalent angular distance to the first post, but in a different direction relative to the eater that the direction to the first post. This step may orient both grips from an axially aligned orientation to an angularly offset orientation, where in the axially aligned orientation, they point towards each other and along an axis that is extends through both post axes, and in the angularly offset orientation, the grips are angularly offset from this axis, in opposite directions. The plurality of sequential steps may include rotating the second post away from the user and rotating the first post towards the user.

In some example embodiments, at least some of the plurality of servos may be operably coupled to their corresponding post axes, such that the first and second posts may move independently of each other. The first and second posts may rotate an angular distance between 10-20 angular degrees from an axis that extends through both the post axes. At least some of the plurality of servos may be operably coupled to the first and second grips between their open and release configuration, such that they can be independently moved. In some embodiments, the device may include a home switch that positions the food handling mechanism in a home position, the home position includes positioning both the first and second grips in the gripping position and both the first and second posts are orientated so as to point the first and second grips towards each other. The device may include a switch labelled open, configured to place the food handling mechanism in an open position, wherein in the open position both the first and second grips are in an open position, configured to allow handheld food to be placed on the first and second tray.

When the first grip is in the release position, the first tray may have a surface that allows the first side of the handheld food to slide along the first tray. The first tray may be removably coupled to the first post, and the second tray may be removably coupled to the second post. When the trays are coupled to the corresponding posts, rotation of the posts simultaneously rotates the corresponding tray a corresponding angular distance.

Another example embodiment of a device is also disclosed, the device for holding and advancing a handheld food for persons with limited or no use of their arms. The device may include a base and a controller including a memory and processor, the memory storing a program that when executed by the processor, causes to processor to command two opposing sides of a food handling mechanism to movingly cooperate with each other to hold, release and advance the handheld food. The two opposing sides including a first and second side. The first side may include a first post that may angularly rotate about a first post axis upon receiving a command from the processor to do so. The first side may also include a first tray coupled to the first post for supporting a first side of the handheld food. The first side may also include a first grip pivotally coupled to the first post; the first grip controlled to pivotally move from a gripping position to an open position. In the gripping position, the first grip is positioned to engage the first side of the top surface of the handheld food, and in the open position, the handheld food is slideable, along the first tray, and slideable relative to the first grip. The second side may include a second post that may angularly rotate about a second post axis, upon receiving a command from the processor to do so. The second side may also include a second tray coupled to the second post for supporting a second side of the handheld food. The second side is on an opposite side of first side. The second side may also include a second grip pivotally coupled to the second post, that may move from a gripping position to an open position, wherein in the gripping position the second grip may engage the second side of a top surface of the handheld food, and in the open position, the handheld food is slideable relative to the second grip.

The device may advance the handheld food by first moving the first grip from a first grip gripping location on the handheld food, to the open position and then rotating the second post to rotate and slide the handheld food relative to the first grip and then returning the first grip to the first grip gripping position to grip the handheld food at a different location than the first grip gripping location. The device may then advance the handheld food by moving the second grip disposed at a second grip gripping location on the handheld food to the open position (of the second grip) and then rotating the first post to rotate and slide the handheld food relative to the second grip and then returning the second grip to the second grip gripping position to grip the handheld food at a different location than the second grip gripping location.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

The disclosure will be more fully understood by reference to the detailed description, in conjunction with the following figures, wherein:

FIG. 1A illustrates a front side view of an example automated feeding device embodiment, in accordance with this disclosure;

FIG. 1B illustrates a right-side view of the example automated feeding device embodiment shown in FIG. 1A, in accordance with this disclosure;

FIG. 1C illustrates a top view of the example automated feeding device embodiment shown in FIG. 1A, in accordance with this disclosure;

FIG. 2A illustrates an isometric view of another example automated feeding device embodiment, in accordance with this disclosure;

FIG. 2B illustrates a front side view of the example automated feeding device embodiment of FIG. 2A, in accordance with this disclosure;

FIG. 2C illustrates a top view of the example automated feeding device embodiment of FIG. 2A, in accordance with this disclosure;

FIG. 2D illustrates a left side view of the example automated feeding device embodiment of FIG. 2A, in accordance with this disclosure;

FIG. 3 illustrates an isometric view of a pizza shelf on an automated feeding device embodiment, in accordance with this disclosure;

FIGS. 4A-4B illustrate a top view and an isometric view of an automatic feeding device in an open or loading configuration, in accordance with this disclosure;

FIGS. 5A-5B illustrate a top view and an isometric view of an automatic feeding device in a gripping configuration, in accordance with this disclosure;

FIGS. 6A-6H, and 6J-6M illustrate both top views and isometric views of the steps of progressing the handheld food, in accordance with any of the embodiments in this disclosure;

FIG. 7 schematically shows an example system diagram of a control system for operating programs of the feeder, in accordance with any of the embodiments in this disclosure;

FIGS. 8A and 8B illustrates an example pair of grips and trays in accordance with this disclosure; and

FIG. 9 illustrates another example pair of grips and trays in accordance with this disclosure.

### DETAILED DESCRIPTION

In the description that follows, like components have been given the same reference numerals, regardless of whether they are shown in different examples. To illustrate example(s) in a clear and concise manner, the drawings may not necessarily be to scale and certain features may be shown in somewhat schematic form. Features that are described and/or illustrated with respect to one example may be used in the same way or in a similar way in one or more other examples and/or in combination with or instead of the features of the other examples.

As used in the specification and claims, for the purposes of describing and defining the invention, the terms “about” and “substantially” are used to represent the inherent degree of uncertainty that may be attributed to any quantitative comparison, value, measurement, or other representation. The terms “about” and “substantially” are also used herein to represent the degree by which a quantitative representation may vary from a stated reference without resulting in a change in the basic function of the subject matter at issue. “Comprise”, “include,” and/or plural forms of each are open ended and include the listed parts and can include additional parts that are not listed. “And/or” is open-ended and includes one or more of the listed parts and combinations of the listed parts. Use of the terms “upper”, “lower” or “upwards” and the like is intended only to help in the clear description of the present disclosure and are not intended to limit the structure, positioning and/or operation of the disclosure in any manner.

Methods recited herein may be carried out in any order of the recited events, which is logically possible, as well as the recited order of events. Furthermore, where a range of values is provided, it is understood that every intervening value, between the upper and lower limit of that range and any other stated or intervening value in that stated range is encompassed within the invention. In addition, it is contemplated that any optional feature of the inventive variations described may be set forth and claimed independently, or in combination with any one or more of the features described herein.

All existing subject matter mentioned herein (e.g., publications, patents, patent applications and hardware) is incorporated by reference herein in its entirety except insofar as the subject matter may conflict with that of the present invention (in which case what is present herein shall prevail). The referenced items are provided solely for their disclosure prior to the filing date of the present application. Nothing herein is to be construed as an admission that the present invention is not entitled to antedate such material by virtue of prior invention.

Disclosed herein is an automated handheld food feeder, hereinafter “feeder” that manages handheld foods while being eaten. Feeder may include generally at least two opposing motorized arms, each arm including two axes of rotation; a first axis of the two axes opens and closes a grip of the arm to engage and disengage the handheld food, and a second axis of the two axes rotates the arm relative to the eater, each action (rotation) maybe moved as part of a programmed motion cycle. Each arm may include a tray. A supplementary removable tray may be used when supporting a long sandwich or large slice of pizza. Some of the components of the feeder, including trays and arms may be removably attached, and may snap in and out of place for easy cleaning. The feeder may be mounted to a table or chair arm and positioned as necessary for food to be adjacent to the eater to reach his or her neck and take a bite. The mounting of the feeder may be into a fixed bracket for install and removal or a quick clamp. A sanitary cover may be selectively used to protect the feeder after cleaning and before the next use. The feeder may couple to a table and adjust vertically to meet the correct ergonomic position for eaters with upper torso motion capabilities. The feeder may include an adjustment arm for those with limited torso motion capability.

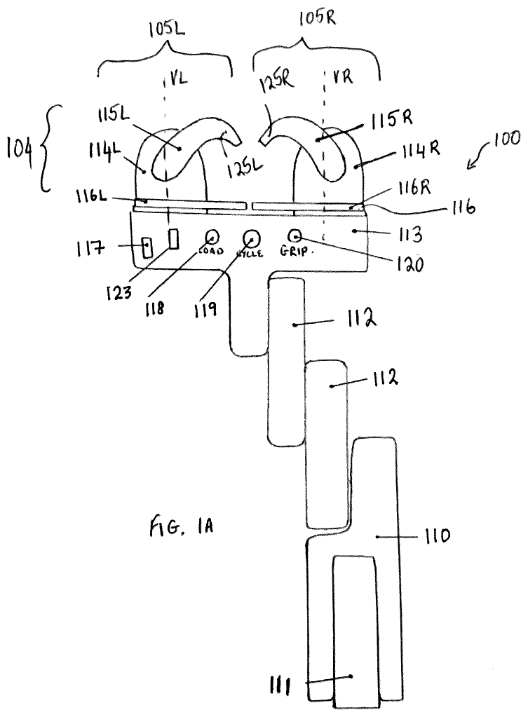

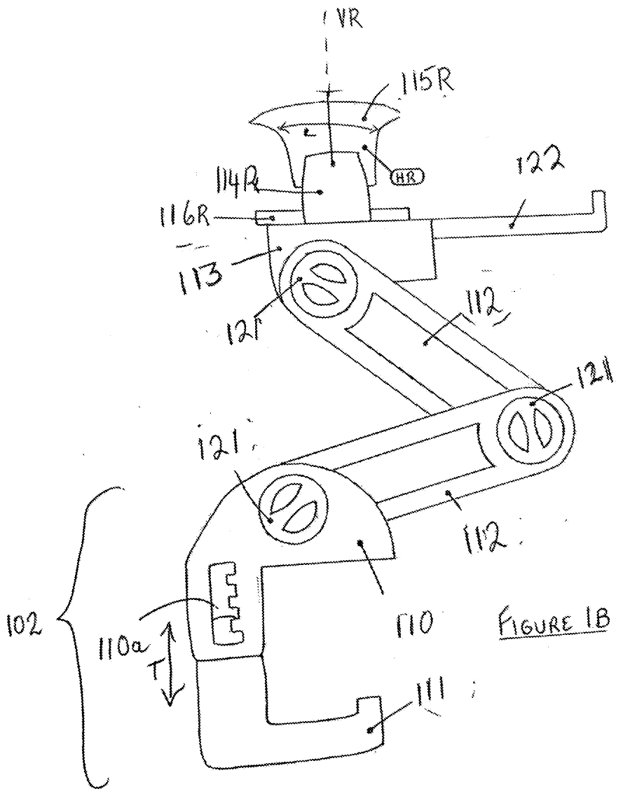

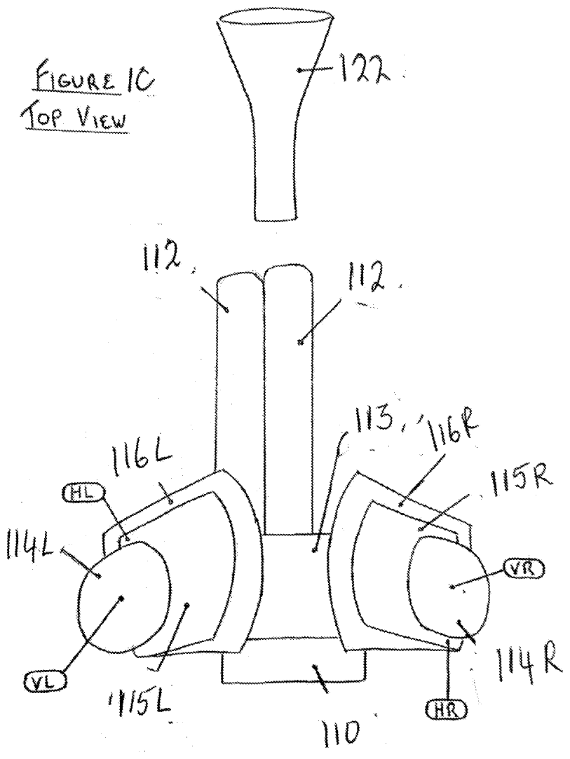

FIGS. 1A-1C illustrates a first embodiment feeder 100. Feeder 100 may be a standalone portable device, that may be readily carried and/or include wheels (not shown) so as to easily transport. Feeder 100 may be adjustable for different height needs. Feeder height may adjust to accommodate fixation to a chair seat, a tabletop, or from the floor adjacent the eater. Feeder 100 may include arms that provide gripping means to hold and incrementally advance a range of handheld food sizes. Feeder 100 may include a controller operatively coupled to controlling means such as switches as defined herein to operate the feeder 100.

Feeder 100 may include base 102 that may include means to fixedly secure it to a surface such as a bed rail, table, or edge of a chair. For example, as shown in FIGS. 1A and 1B, feeder 100 may include a clamp and may include a first jaw 110 and a second jaw 111 that may slide relative to each other to clamp around an edge of a chair or table. First jaw 110 may telescopically (T) move within an open post of second jaw 111. First and second jaws 110, 111 may include selectively engaging means such as teeth or keyed slots that allow the distance between the two jaws (110, 111) to be selectively fixed. Other means of controlling the distance between the two jaws to grip a table or bed rail are known in the art and may include suction cups, plastic clips, magnets, cam locking clamp system, or threaded shaft on 111 with a hand knob to increase the force. In other example embodiments, the base may include a large foot base that may sit of the ground.

Feeder 100 may be adjustable to adjust height and reach of feeding portion 104. As shown in FIGS. 1A and 1B, feeder 100 may include a plurality of pivoting links 112 (2 links 112 shown) that pivot to fold and unfold and adjust height and reach of feeding portion 104. Each link 112 may couple via a lock 121 that fixes that angle of each corresponding link 112. At least one lock 121 may include a locking cam to lock the position. Adjustment arms 112 lock in position with 121 and may also provide position adjustability both vertically as well as towards (or away) from an eater (horizontal direction) who may not have ability to lean forward with torso.

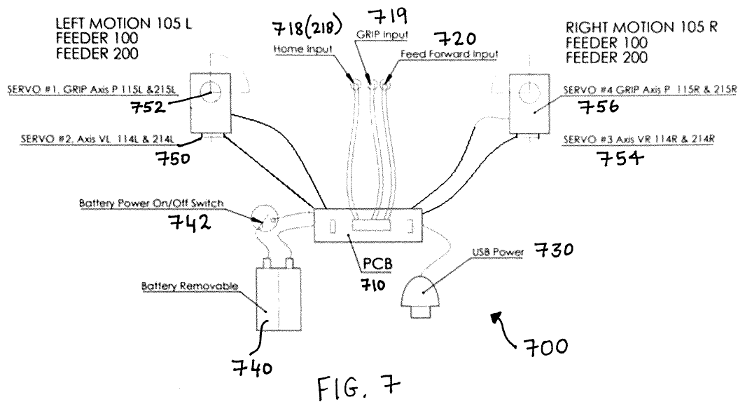

A top-most link 112 may pivotally couple to a housing 113. Housing 113 may house a control board and a plurality of servos, hereinafter “servos”, operatively coupled thereto (not shown), a schematic of an example control board shown in FIG. 7.

Turning briefly to FIG. 7, control system 700 is schematically shown, including a control board (PCB) 710, that includes a memory or a non-transitory storage medium and processor, the memory storing a program that causes the processor to control the servos according to a program, depending on the input from one of a plurality of switches. Inputs may include a home input 718, grip input 719, and feedforward input 720. The servos may include compact motors and may be stepper motors. The servos may drive the feeding mechanism with a motion profile designed to regulate the forward progress of handheld foods for consumption. The servos may define a motor controlled four axis motion system inside housing 113. Essentially the servos control axes of rotation and grip of the feeder. Control system 700 may communicate with a first servo 750, second servo 752, third servo 754 and fourth servo 756. Control system 700 may include USB power 730 and may receive power via a removeable batter 740, with a power switch 742.

The control board and servos are operatively coupled to two opposing arms 105L, 105R of the automated feeding portion 104. Feeding portion 104 may include a left arm 105L and right arm 105R, each side cooperating to grip and regulate advancement of the handheld food. Each side may mirror the other side, relative to a vertical plane that bisects the housing 113. Each side preferably moves independently so as to control advancing of the handheld food in a reliable manner. Starting with the left arm 105L, designated by the letter “L” after each numerical label, the left side 105L includes a left tray 116L, a left post 114L and a left grip 115L. The left post 114L may be vertical and may be secured to the left tray 116L such that rotating of the left post 114L rotates the left tray 116L. Left tray 116L may be configured to snap on to an external surface of post 114L. Tray 116L may define a horizontal surface, when assembled to the post 114L for supporting a portion of the handheld food and may be removeable for easy cleaning after use. The left post 114L may be operatively coupled to a first servo disposed within the housing 113, and operation of the first servo (750) may rotate the left post 114L an angular distance around a post axis (VL). The servo (750) may rotate the left post 114L between 10-90 angular degrees and may more preferably rotate the left post 114L between 10-40 angular degrees. This angular distance may define or partially define a distance the handheld food is progressed upon actuation of the program to incrementally progress the handheld food towards the eater. The inventor has found that this angular distance may be approximately 25 angular degrees for most handheld foods.

Left grip 115L may be rotationally coupled to the post 114L, the left grip 115L axis may be a horizontal axis such that the left grip 115L may rotate down to grip the handheld food and up to release grip thereon. Therefore, left grip 115L may be operatively coupled to a second servo (752), independently operated from the first servo. Second servo (752) may move the left grip 115L an equal angular distance between a first position that grasps the handheld food and a release position that releases grasp of the handheld food.

Moving now to the right arm 105R designated by the letter “R” after each numerical label, the right arm includes a right tray 116R, a right post 114R and a right grip 115R that all operative in a similar fashion to the left side. The right arm 105R is a mirror image and while the two sides operate independently (as described later), they also cooperate with each other to grip and advance the handheld food.

The inventor envisioned several positions for the grip 115L (as well as the right grip 115R). A gripping position may be defined as one that engages the top surface of the handheld food while the corresponding tray supports the under surface. This feeder 100 is in this position when stabilizing the food while it is being eaten, and also moves the food during the progress cycle. In the gripping position the grip may be approximately horizontal. In some configurations, grips (115L, 115R) may be switched out with different shapes to accommodate different foods. For example, the grip to engage a burrito may be more rounded that a grip to engage a sandwich or pizza. In other configurations, the grips 115L, 115R may receive extenders that attached over the grips, to change the shape or geometry for different handheld foods. In some embodiments, the gripping position may be fine-tuned to accommodate thicker or thinner foods. Therefore, feeder 100 may include a switch (as defined herein) that may adjust the gripping position orientation, for use with a thin pizza slice for example. The grips 115L, 115R may also have an open position, that may position the grip towards a vertical orientation (that may also be termed the 180-degree position). This position provides significant clearance to allow for easy loading of the handheld food onto the left and right trays 116L, 116R. In some embodiments there may also be a release position, that lifts a grip of the two grips 115R, 115L slightly. This position may be somewhere between the gripping and open position (200-degree position), sufficient for the handheld food to slide relative to that same grip, but still provide some back up to limit the handheld food from falling out. Grips 115L, 115R may include a curved or hooked end 125R, 125L to engage the handheld food. Grips have a length L (best seen in FIG. 1B) that is longer than a diameter of a corresponding vertical post 114L, 114R, and this length L may increase to a maximum length of the grip 115R, 115L at the distal food engaging tip of each grip 115R, 115L. This may increase the footprint for gripping the food as it advances. Each tray 116R, 116L may define a horizontal surface that engages and supports the handheld food, and may be a highly polished surface, configured to allow the food to slip along a tray surface more readily, allowing for easy food advancement towards the eater.

Controlling the positions of the grips 115R, 115L may be via a plurality of switches that may be integral with housing 113. In some example embodiments, the switches may include a home or load position switch 118, a grip switch, an advance cycle switch 119 and a grip switch 120. Upon actuation of the home position switch, a program stored in the control board memory may communicate with the processor to cause the corresponding servos to move both grips 115R, 115L to a home location, that may move each grip 115L, 115R to an open position, as described herein. Each grip may move simultaneously or serially. Upon actuation of the grip switch 120, a program stored in the control board memory may communicate with the processor to cause the corresponding servos to move both grips 115R, 115L to a gripping position, as described herein. The position may be at 225 degrees. Upon actuation of a fine-tune switch, the grip on the handheld food may be adjusted. In some embodiments, the feeder 100 may have location sensors or force sensors to move the grips 115L, 115R to a position that lightly engages the handheld food with a defined holding low level grip force. In some embodiments, each grip 115R, 115L may include an adaptor that alters the shape of the grip. The adaptors may snap on. The adaptors are configured to increase or decrease grip force and holding geometry to control differing shapes of foods.

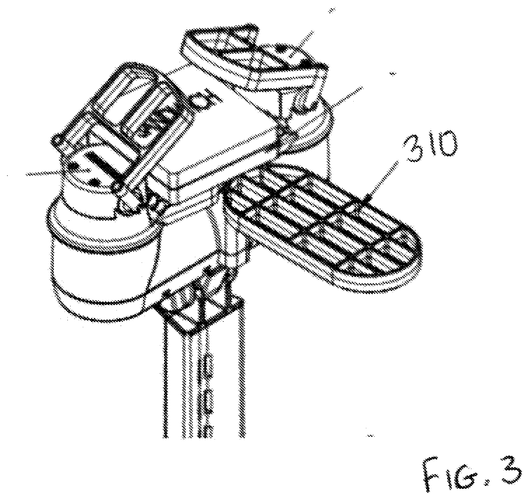

Housing 113 may include batteries for providing energy to the controller and servos. In other embodiments feeder 100 may plug into a wall outlet. A rear removable support 122 and 310 (FIG. 3) may snap in and out as needed to the feeder. This tray or support may support a long sub sandwich or pizza slice, as needed. Switch 117 may be a USB power option and switch 123 may Power On and off the feeder 100.

### Second Example Embodiment

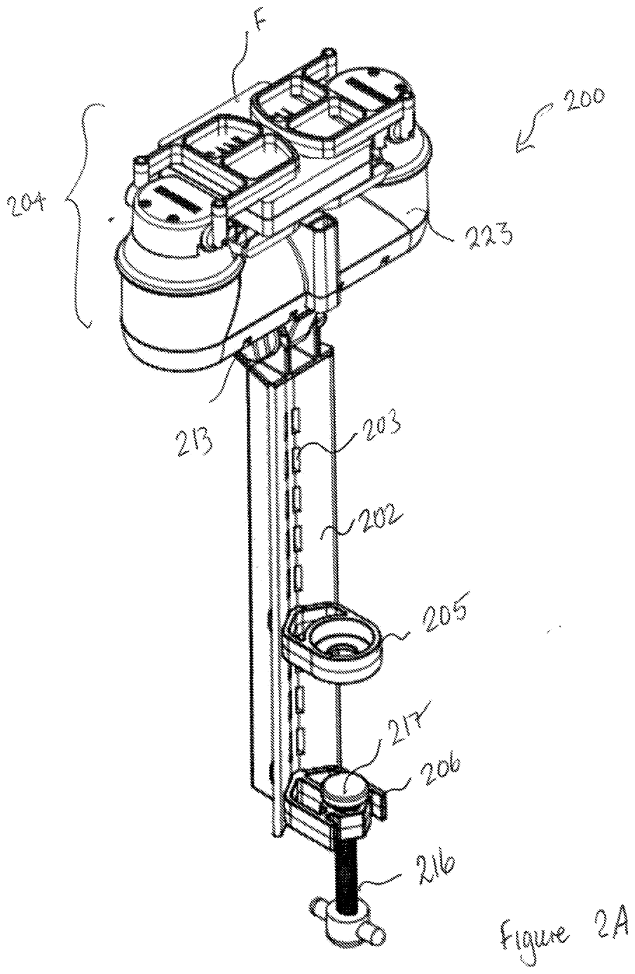

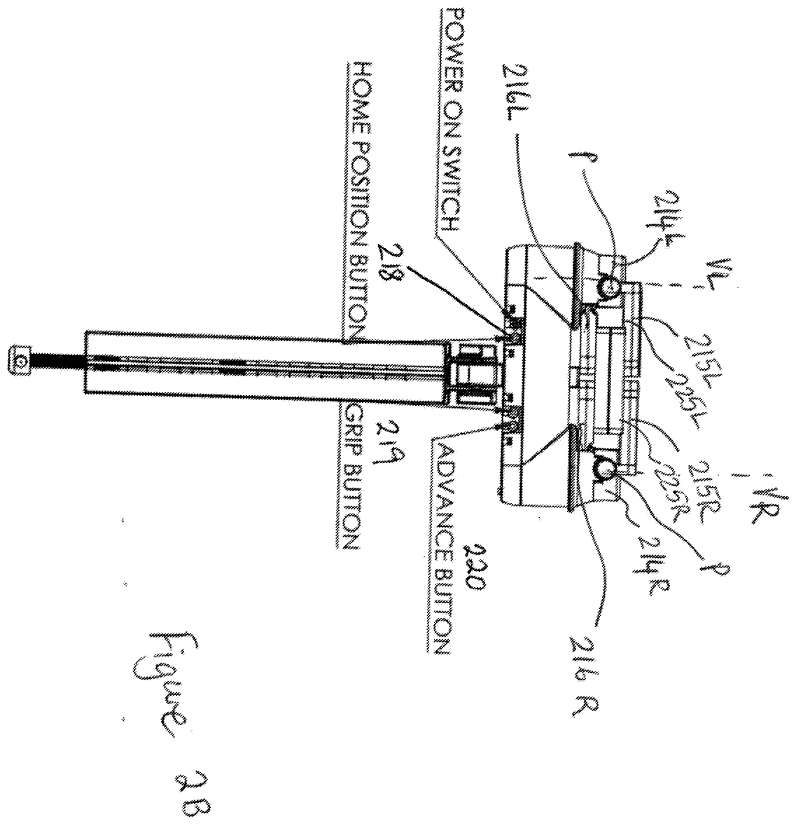

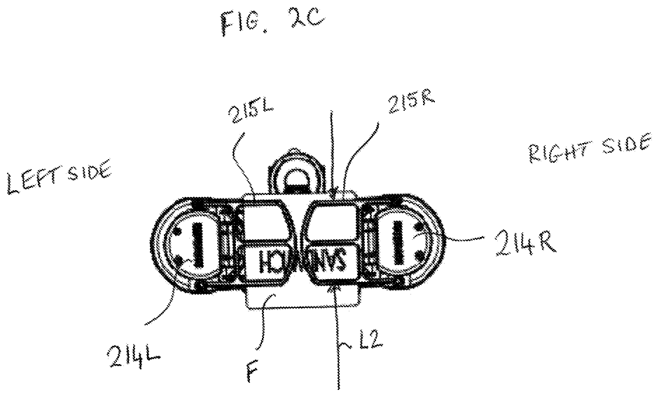

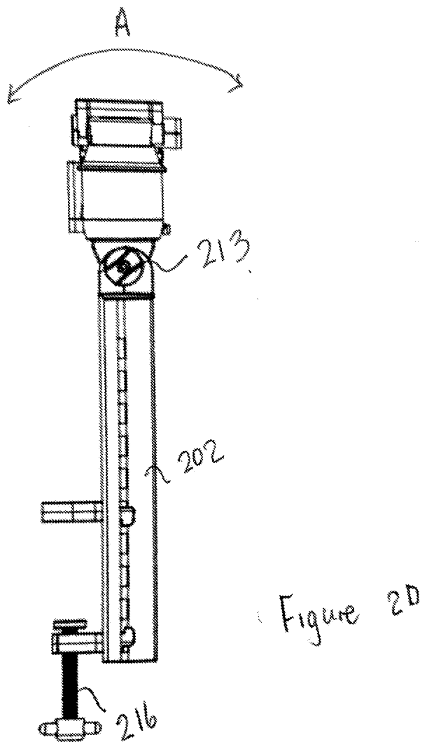

FIGS. 2A-2D illustrate another example embodiment feeder 200, similar to feeder 100. Feeder 200 may be a standalone portable device, that may be readily carried and/or may include wheels (not shown) for easy transport. Feeder 200 may be adjustable to adjust to different height needs. Feeder 200 includes gripping means to hold and incrementally advance a handheld food. Feeder 200 may include a controller having a memory and processor, the controller operatively coupled to switches, as defined herein, to operate the automated feeding portion 204 of feeder 200.

Feeder 200 may include support rail 202 that may include a vertical post configured to support the feeding portion 204. Support rail 202 may be able to stand, unsupported. Support rail 202 may include means to fixedly secure it to a surface such as, but not limited to a bed rail, table or chair rest, or edge of a chair. Support rail 202 may include a plurality of slots 203 that selectively receive clamp arms 205, 206. Clamp arms 205, 206 may be selectively moved and inserted into a slot of the plurality of slots 203, to closely adjust to an edge of a chair or table. In addition, at least one of the clamp arms 205, 206 may threadingly receive a locking knob 216. Rotating of locking knob 216 may vertically raise the knob surface 217 to engage an underside of a table, for example, similar to a C-clamp, known by those skilled in the art.

Feeder 200 may include a telescoping post 201, such that an inner post (not shown) may slide relative to outer post 202 to adjust height of feeder portion 204. Feeder portion 204 may be rotatable (arrow “A”) relative to post, lockable via locking knob 213 in an angled position relative to post axis. In some embodiments, links similar to links 112 in feeder 100 may extend from post 201 to be able to reach away from table for example and be positioned closer to the eater this pivot and allow Feeder 200 to or object it is clamped to.

Similar to feeder 100, feeder 200 includes a housing 223 that may house a control board (with a memory and processor) and a plurality of servos and gears, the control board in operative communication with the servos and gear. An example schematic is illustrated in FIG. 7. The servos are configured to provide a motorized controlled four axis motion system inside housing 223. The control board 710 and servos (750, 752, 754, 756) are communicable coupled to the switches as defined herein. The inventor preferred a servo system, as he found that this provided a preferred action for reliably progressing or advancing the handheld food, that included predominantly a rotation and pivoting driven automation. While linear action, such as a bulldozer style advancement was contemplated and tested, this was found to be less reliable and more prone to food sticking or crumpling during testing.

Similar to feeding portion 104, feeding portion 204 may include a left arm and a right arm, as viewed by the eater and seen best in FIG. 2C. Each side cooperates to grip the handheld food F and also regulate advancement thereof (the food is illustrated in these images as a sandwich). Each side may mirror the other side, relative to a vertical plane that bisects the housing 223, although each side may be moved independently by the control board and servos. For example, starting with the left side designated by the letter “L” after each numerical label, the left side may include a left tray 216L, a left post 214L and a left grip 215L. The left tray 216L may be removeable coupled to the left post 214L. Left tray 216L may snaps onto, into or around an external surface of vertical post 215L. Tray 216L may define a horizontal surface for supporting a portion of the handheld food F and may be removeable from the left post 214L for easy cleaning. The left post 214L may be a vertical post and may operatively couple to a first servo of the plurality of servos, the servo operable to rotate the post 214L an predetermined angular distance around a post axis (VL). The servo (750) may rotate the left post 214L between 10-90 angular degrees and may more preferably rotate the left post 214L between 10-40 angular degrees. This angular distance may define or partially define a distance the handheld food is progressed upon actuation of the program to incrementally progress the handheld food towards the eater. The inventor has found that this angular distance may be approximately 25 angular degrees for most handheld foods. Too great an angular distance may lead to an incremental progression that provides an excess of the handheld food F exposed and unsupported beyond the feeder 200. For thinner foods, this may allow the food to drop portions of the sandwich, for example to fall out. Rotating the post 214L also rotates the grip 215L and tray 216L.

Left grip 215L may be pivotally coupled to the post 214L, at axis P. The left grip 215L axis P may be a horizontal axis such that the left grip 215L may rotate down to the gripping position as discussed herein to engage the handheld food F and rotate up to release grip thereon (to the release or open position). Therefore, left grip 215L may be operatively coupled to a second servo of the plurality of servos, independently operated from the first servo. Second servo may move the left grip 215L an angular distance between the gripping position and the open or release position. In addition, there may be another switch that provides a fine-tuning option, for example that may alter this gripping position in smaller micro-increments, for thicker breads or thinner pizzas for example.

Grip 215L may define elongate paddles that extends medially and may include an underside surface 225L that is planar. Grip 215L may define a windowed paddle, in that large portions of the paddle have openings therethrough, to reduce weight of the paddle and lower demand on the servo motors. Grip 215L may hold food with a larger surface area, compared to grip style 115L, and reduce any digging or cutting into the handheld food. A range of paddles or grips may be provided such as burger teeth grips, burrito cupping or curved grip to wrap over the top of the cylindrical burrito shape, a longer teeth grip for pizza. In some embodiments, Lower tray 216L also can switch out if required for geometry changes as well as the dishwasher cycle.

Moving to the right side designated by the letter “R” after each numerical label, the right side is a mirror image of the left side, although is independently coupled to the control system, (board and servos) as will be explained in more detail later. Right side includes a right tray 216R, a rightpost 214R and a rightgrip 215R. The rightpost 214R and right tray 216R may be removably coupled from each other. Right tray 216R may have a cavity that snaps around an external surface of vertical post 215R. Tray 216R may define a horizontal surface for supporting a portion of the handheld food F and may be removeable from the rightpost 214R for easy cleaning. The rightpost 214R may be operatively coupled to a third servo, that rotates the post 214R an angular distance around a vertical axis (VR). The servo (754) may rotate the right post 214R between 10-90 angular degrees and may more preferably rotate the right post 214L between 10-40 angular degrees. This angular distance may define or partially define a distance the handheld food is progressed upon actuation of the program to incrementally progress the handheld food towards the eater. The inventor has found that this angular distance may be approximately 25 angular degrees for most handheld foods. Rotation of post 214R rotates the right grip 215R and right tray 216R.

Rightgrip 215R may be pivotally coupled to the post 214R, at axis P. The rightgrip 215R axis P may be a horizontal axis such that the rightgrip 215R may rotate down (counterclockwise) to engage the handheld food F and rotate up (clockwise) to release grip thereon. Therefore, rightgrip 215R may be operatively coupled to a fourth servo (756), independently operated from the first second and third servo (750, 754) via the control board (710). Fourth servo (756) may move the right grip 215R an angular distance between a gripping position and an open position, or release position, as defined herein. In addition, there may be a second switch that provides a fine-tuning option, for example that may alter this gripping position in smaller micro-increments, to accommodate for thicker pieces of cake or thinner cookies for example. As discussed herein, adaptors may be fittingly coupled to ends of the grippers to close the grip tighter and address the type of food as development continues. your call on how to include this mystery geometry. The open position may rotate the grip 215R up to a vertical position, which may be designated as 180 degrees. The open position may rotate the grip 215R between 45-90 angular degrees from the gripping position. In some embodiments, where more control of the food F is required, there may be a release position which barely rotates the grip 215R enough to allow the food F to slip by the grip surface. In this example, the grip 215R may rotate less than 20 degrees from the gripping position to the release position.

Grip 215R may define a paddle that extends medially and may include a lower surface 225R that is planar. Grip 215R may define a windowed paddle, in that large portions of the grip 225R have openings therethrough, to reduce weight of the arm and lower demand on the servo motors. Other grip shapes that may be interchangeable may be provided, as discussed herein.

Each grip 215L, 215R may have a length L2 (best seen in FIG. 2C) that engages a sufficient length of a food F to retain it and resist being pulled out while the eater is biting onto the food F. As the food advances and is eaten, less remaining portions of the food remain to be gripped, therefore this length L2 may approximate a hand width which may help to stabilize the shrinking remains of the handheld food. Each grip 215L, 215R may be configured to engage but avoid piercing the handheld food, as this may interfere with operation of the automated feeding mechanism. Each tray 216R, 216L may define a horizontal surface, or near horizontal surface, to engage and support the food. This surface may be a highly polished surface, configured to allow the food to slip along each tray surface more readily, allowing for easy food advancement towards the eater. In some embodiments the tray surface may be tipped down slightly, to help the food slip towards the eater.

In some embodiments, feeder switches may include a home or load position switch 218, a grip switch 219 and an advance cycle switch 220. Upon actuation of the home position switch, a program stored in the control board memory may communicate via a processor to move the corresponding servos (second and fourth) to move both grips 215R, 215L to a home location. Home is equal to actual 180 degrees on axis P. This position may orient each grip 215L, 215R in an open configuration that allows for loading a handheld food into the trays 216L, 216R. This open configuration may automatically move both grips 215R, 215L to or towards a vertical orientation, for example. This open configuration (home position) may automatically move each grip 215R, 215L to an angular orientation that allows removal or loading of the handheld food. This open configuration may open the grips 215L, 215R between 30-60 angular degrees as measured from a gripping position. Gripping position may be 225 degrees on Gripping servo's P.

Actuation of the grip switch 220 may move each grip 215L, 215R to a position that engages the handheld food F, or a gripping position, as defined herein. This gripping position may place the grips 215L, 215R in an approximate horizontal orientation. This grip position may be fine tuned for different food thicknesses. The gripping position may also point the two grips 215L, 215R towards each other, as shown in FIG. 2C.

FIG. 3 illustrates an optional tray extension 310 that extends from the housing 223 opposite the eater. For larger food items, such as a long foot long sub or a pizza slice, this tray extension may better support that food F.

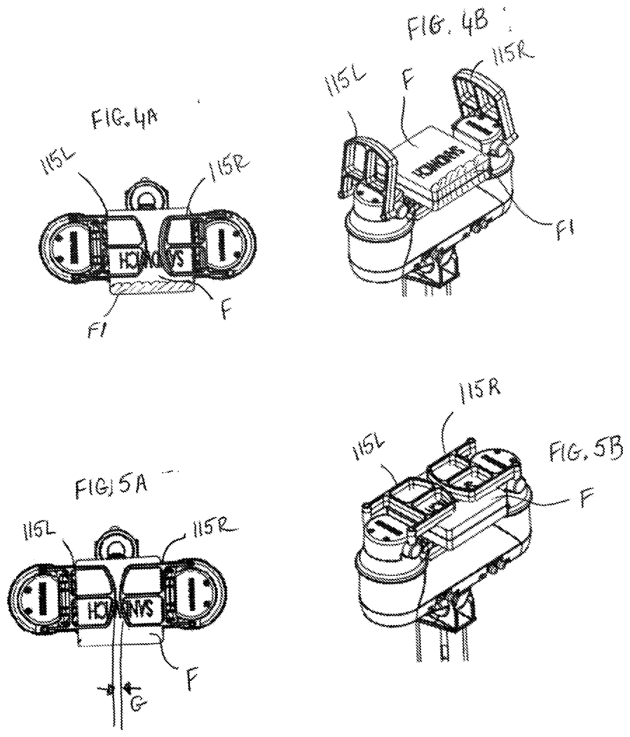

FIGS. 4A and 4B illustrates a top view and isometric view respectively, of the feeding portion 204 in the open position. The control board receives an input, that may be via actuation of a loading or home switch 218. This input may cause the processor to cause the second and fourth servos to actuate and move both grips 215L and 215R, to move towards the open position that may be the designated a 180-degree position, or vertical orientation. A handheld food F may now be loaded. The handheld food F may be preferably loaded offset towards the eater, to provide a food portion F1 extending beyond the grips 215L and 215R, that may be easily accessed and eaten.

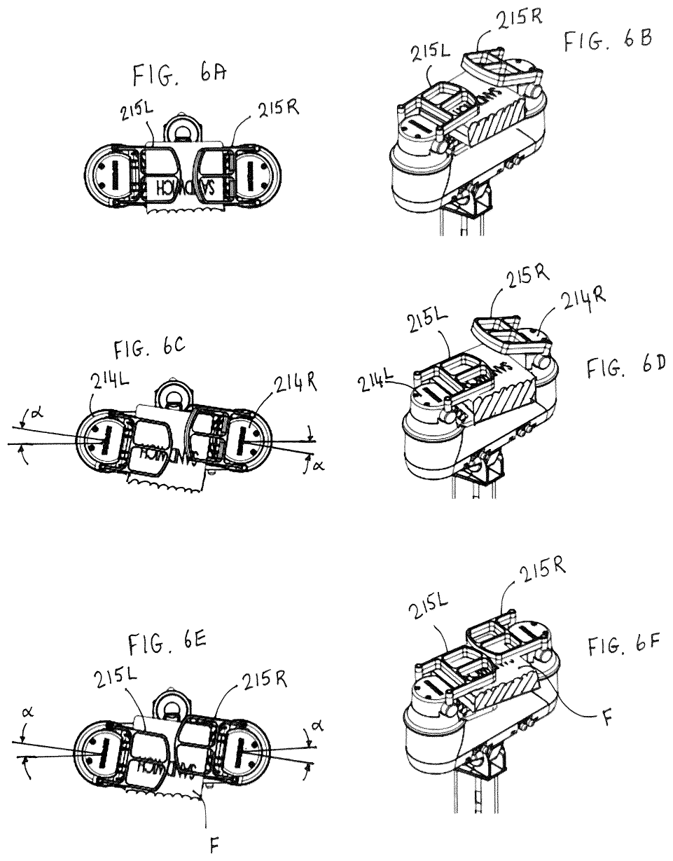

FIGS. 5A and 5B illustrates a top view and isometric view respectively, of the feeding portion 204 in the gripping position. The control board receives an input, that may be via actuation of a grip switch 219. This input may communicate with a program stored in the control board memory, the program configured to cause the processor to actuate a second and fourth servo (P-axis servos) that causes grips 215L and 215R, to move towards a top surface of the food F. This may approximate a horizontal orientation. The handheld food F is now loaded and held in position, offset towards the eater, such that food portion F1 extends beyond the grips 215L and 215R, to be easily accessed and eaten. In the gripping position, the food F is held sufficiently to resist movement while the eater is taking a bite. For different foods, this position may be fine-tuned using another switch for example to adjust the closed configuration. In the gripping position, each grip pair 215L and 215R may be directly adjacent to each other with minimal gap G to stably hold the food F.

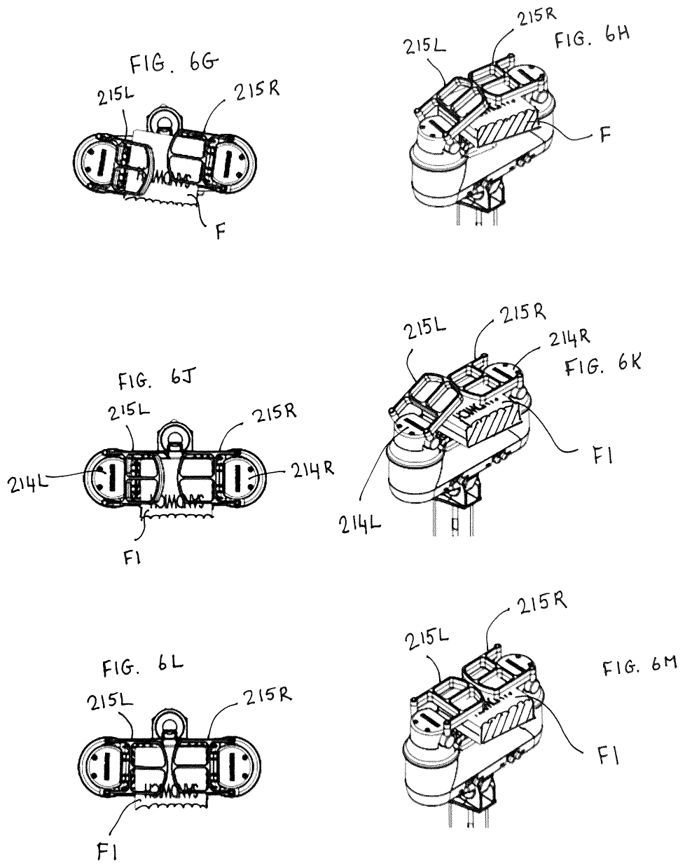

FIGS. 6A-6H illustrate the steps the feeding portion 204 may cycle through, upon actuation of a switch that is configured to advance the handheld food an incremental distance. This switch is in communication with the control board (710), that has a memory that stores a program that commands the processor to drive the servos (750, 752, 754, 756) to move the feeding portions (104, 204) per the steps disclosed below.

Once a few bites of the food F have been taken, removing portion F1 approximately, actuation of a cycle switch or advance switch may initiate a sequence of operations, as follows. The sequence may begin in the gripping position shown in FIGS. 5A and 5B, except that a portion F1 of the food has been eaten. Actuation of switch may communicate with a program stored in the control board memory, the program causing the processor to first move one grip only while the other remains stationary. In this example, grip 215R moves to the open position, with the other grip 215L remaining stationary. It should be understood however that the sides are chosen by way of example, and if flipped, the operation remains the same. FIGS. 6A and 6B illustrates a top view and isometric view respectively, of the feeding portion 204 after the first step of the sequence is complete, with grip 215R lifted and grip 215L still in the gripping position, engaging the food F. From a servo perspective, the program causes the processor to cause only the fourth servo (756) (Right P axis servo) to move, to a position that releases hold of the food F.

The second step may include rotating post 214R (via servo 754) an angular distance α (that may be approximately 12.5 degrees) in a first direction that may be clockwise, as shown in FIG. 60, while the grip 215R is still in the open position and either simultaneously or serially rotating post 214L (via servo 750) a similar angular distance α (that may be approximately 12.5 degrees) also in the same direction (clockwise). Grip 215L is still gripping the food F during this step. Stated another way, the right grip 215R (via servo 754) pivots away from eater with an open grip and the left grip rotates toward user (via servo 750) with food gripped. At this point in the cycle, the food may be parallel to the grip 215R when the motion is complete. This second step begins to rotate handheld food F towards the eater. From a servo perspective, the program instructs the processor to cause the first and third servos to move either serially or simultaneously an angular distance α, while the second and fourth servos remains stationary. Notable during this second step the food slides relative to tray 216R but since grip 214L is in the gripping position, the food F does not slide relative to tray 216L.

FIGS. 6E and FIG. 6F illustrates a top view and isometric view respectively, of the feeding portion 204 after the third step of the sequence, where grip 215R has returned to the gripping position, all be it a different portion of the food F. As can be seen in both of these figures, the two grips 215R and 215L are now engaging the food F an angularly offset from each other. From a servo perspective, this step involves causing only the fourth servo to move the grip 215R position to the gripping position. The remaining food is now in a slightly rotated position.

FIGS. 6G and 6H illustrates a top view and isometric view respectively, of the feeding portion 204 at the end of the fourth step of the sequence, that lifts grip 215L to an open position (or release position) while grip 215R remains stationary and in the gripping position. From a servo perspective, the processor causes only the second servo (752) to move.

FIGS. 6J and 6K illustrates a top view and isometric view respectively, of the feeding portion 204 at the end of the fifth step of the sequence, wherein during the fifth step, both grips 215L, 215R may rotate back towards each other, so as to be pointing towards each other. However, during this rotation, only the right grip 215R is gripping the food F. This acts to rotate the left side of the remaining food F towards the eater. From a servo perspective, the processor causes the first and third servo, to rotate the left post 214L and right post 214R respectively. Posts 214L, 214R may rotate simultaneously or serially. First servo is operatively coupled to the left post 214L and third servo is operatively coupled to the right post 214R.

FIGS. 6L and 6M illustrates a top view and isometric view respectively, of the feeding portion 204 at the end of the sixth step of the sequence. This may be the final step of the programmed cycle, after which the eater may proceed to eat more of the handheld food. During this sixth step, grip 215L may move to the gripping position, while grip 215R remains stationary and engaging the remaining food F. From a servo perspective, the program communicates with the processor to cause the second servo, operatively coupled to the left grip 215L to move to the left grip 215L to the gripping position.

The eater may then take a few bites into the projecting portion of the remaining food F and then initiate the advancing cycle once again.

In some embodiments, the rotating angle a of each post 214L, 214R may be adjustable such that each incremental advancement is smaller or larger. More substantial foods or thicker breads for example may be able to stand up to larger incremental advancements than thinner food such as thin pizza slices, for example. Alternatively, a second cycle may be initiated.

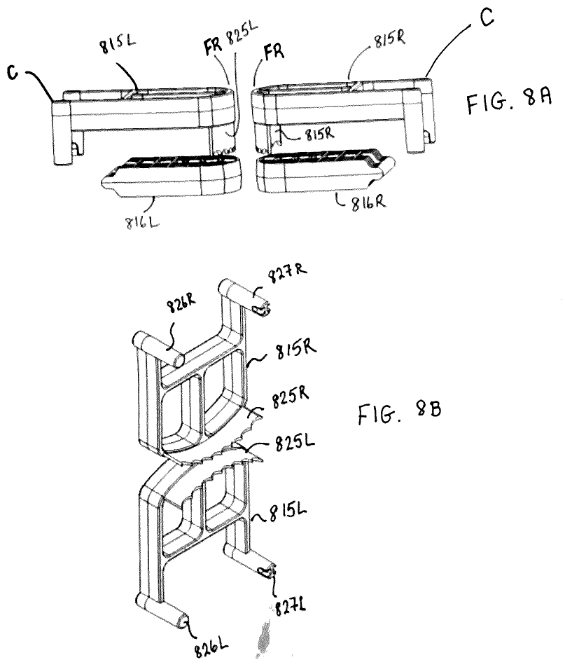

FIGS. 8A and 8B illustrate various views of an embodiment of a pair of grips 815L, 815R, and trays 816L, 816R. Grips may include a coupled end, labelled “C” that may pivotally couple to a corresponding post and a free end labelled “FR”. Grips 815L, 815R may be similar to previously disclosed grips (215R, 215L, 115R, 115L) except that they may include a projection 825R, 825L at or adjacent to free end FR. Projections 825L, 825R may be obtained as a separate adaptor that may be selectively connected to a corresponding grip 215R, 215L for example. Projection 825R, 825L may define an arced projection that extend around and matches a curved free end of each grip 815R, 815L. Projections 825R, 825L may terminate with a plurality of teeth or jagged ends to better engage the handheld food. Projections 825R, 825L may have an adjustable projection height or a plurality of projections may be provided having different heights. Projections 825R, 825L may help engage thinner handheld foods such as pizza. Each grip 815R, 815L may have a first post 826R, 826L at the coupled end “C” and a second post 827R, 827L. First post 826R, 826L may be an inert end. Second post 827R, 827L may include a keyed portion to operable couple to a shaft to transfer the pivoting motion of each grip. In other embodiments, the separate single body grip may be part of the kit provided.

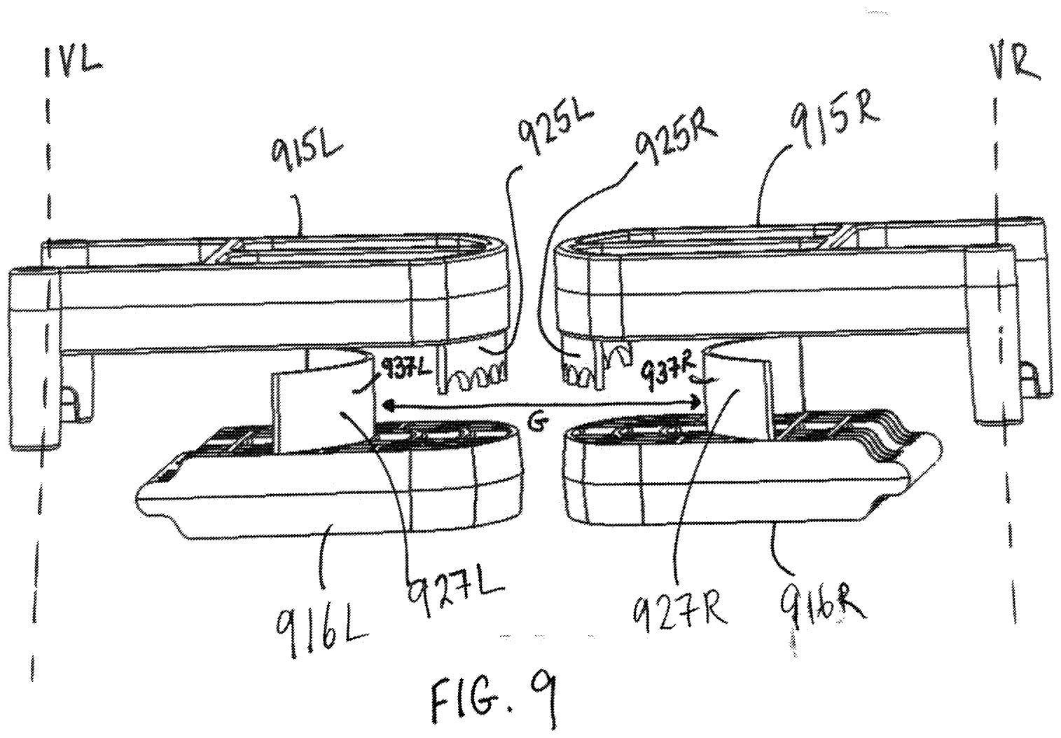

FIG. 9 illustrates an embodiment of a pair of grips 915L, 915R, and trays 916L, 916R. FIG. 9 illustrated an optional grip and tray arrangement that may preferably hold a burrito of cylindrical shaped handheld food. Grips 915L, 915R may be similar to grips 815L, 815R in that they may include arced projections 925L, 925R. These arced projections 925L, 925R may be shorter than arced projection 825L, 825R. Of note, each tray 916L, 916R may include tray projection 927L, 927R, configured to engage along the cylindrical shaped handheld food. Tray projections 927L, 927R may extend perpendicularly from a central portion of each tray 926L, 916R, and may together define a gap G, when assembled to their corresponding posts that approximates an an average burrito or hot dog diameter. In some embodiments tray projections 927L, 927R may be adjustable along the corresponding tray to adjust gap “G”. Tray projections 927L, 927R may extend along an arc, configured to remaining engaged with the handheld food as the tray is rotated (via rotation of the corresponding post). Stated another way, consider that upon rotation of a post, the corresponding tray also rotates around axis (VR, VL); the arc preferably defines a radial center coincident with the corresponding vertical post axis (VL, VR), such that upon rotation of the post and therefore corresponding tray, the trip projection outer radial surface 937L, 937R remains engaged with the handheld food.

One skilled in the art will realize the disclosure may be embodied in other specific forms without departing from the spirit or essential characteristics thereof. The foregoing examples are therefore to be considered in all respects illustrative rather than limiting of the disclosure described herein. Scope of the disclosure is thus indicated by the appended claims, rather than by the foregoing description, and all changes that come within the meaning and range of equivalency of the claims are therefore intended to be embraced therein.

What is claimed is:

1. A device for holding and advancing a handheld food, by persons with limited or no use of their arms comprising:
a base;
a control housing, housing a controller operably coupled to a plurality of servos, the controller including a memory and processor, wherein the memory stores a program that when executed by the processor, causes to processor to command the plurality of servos to operate a food handling mechanism to hold, release and advance the food, the food handling mechanism coupled to the base and including;
a first side including:
a first post configured to angular rotate about a first post axis;
a first tray coupled to the first post for supporting a first side of the handheld food; and
a first grip pivotally coupled to the first post, the first grip configured to move from a gripping position to an open position, wherein in the gripping position the first grip engages the first side of the handheld food, and in the open position, the handheld food is slideable relative to the first grip; and
a second side including:
a second post configured to angularly rotate about a second post axis;
a second tray coupled to the second post for supporting a second side of the handheld food, the second side opposing the first side; and
a second grip pivotally coupled to the second post, the second grip configured to move from a gripping position to an open position, wherein in the second grip gripping position the second grip engages a second side of the handheld food, and in the open position, the handheld food is slideable relative to the second grip.

2. The device of claim 1 wherein upon the processor receiving an input to advance the food, the program executed by the processor, causes the processor to operate the plurality of servos to cause the first and second side of the food handling mechanism to move through a plurality of sequential steps to advance the food and then hold the food while a user eats.

3. The device of claim 2 wherein the plurality of sequential steps includes
a) moving the first grip to the first grip open position, and while in the first grip open position, rotating the second post to rotate the first side of the handheld food towards the user and then returning the first grip to the first grip gripping position.

4. The device of claim 3 wherein the plurality of sequential steps further comprises:
b) moving the second grip to the second grip open position after returning the first grip to the gripping position, and while the second grip is in the second grip open position, rotating the first post to rotate the second side of the handheld food towards the user and then returning the second grip to the second grip gripping position.

5. The device of claim 3 wherein the plurality of sequential steps further comprises:
c) while rotating the second post, also rotating the first post.

6. The device of claim 5 wherein the plurality of sequential steps further comprises:
d) while rotating the second post towards the user, rotating the first post away from the user.

7. The device of claim 1 wherein the plurality of servos are configured to rotate the first and second posts around their corresponding post axes, independently of each other.

8. The device of claim 7 wherein the first and second posts are configured to rotate an angular distance that is between 10-20 angular degrees.

9. The device of claim 7 wherein the plurality of servos are configured to rotate the first and second grips between their corresponding open and release configurations, independently of each other.

10. The device of claim 1 wherein the device includes a home switch configured to place the food handling mechanism in home position, wherein in the home position both the first and second grips are in their corresponding gripping position and both the first and second posts are orientated to point the first and second grips towards each other and axially aligned with each other.

11. The device of claim 1 wherein the device includes an open switch configured to place the first and second grips in their corresponding open position, configured to allow handheld food to be placed on the first and second tray.

12. The device of claim 11 wherein when the first grip is in the open position, the first tray is configured to allow the first side of the handheld food to slide along the first tray.

13. The device of claim 1 wherein the first tray is removably coupled to the first post, and the second tray is removably coupled to the second post, and wherein when coupled, rotation of the first post also rotates the first tray and wherein rotation of the second post also rotates the second tray.

14. A device for holding and advancing a handheld food, by persons with limited or no use of their arms comprising:
a base;
a controller including a memory and processor, wherein the memory stores a program that when executed by the processor, causes to processor to command two opposing sides of a food handling mechanism to movingly cooperate to hold, release and advance the handheld food, the food handling mechanism including;
a first side including:
a first post configured to angular rotate about a first post axis;
a first tray coupled to the first post for supporting a first side of the handheld food; and
a first grip pivotally coupled to the first post, the first grip configured to move from a first grip gripping position to a first grip open position, wherein in the first grip gripping position the first grip engages the first side of the handheld food, and in the first grip open position, the handheld food is slideable relative to the first grip; and
a second side including:
a second post configured to angularly rotate about a second post axis;
a second tray coupled to the second post for supporting a second side of the handheld food, the second side opposing the first side; and
a second grip pivotally coupled to the second post, the second grip configured to move from a second grip gripping position to a second grip open position, wherein in the second grip gripping position the second grip engages the second side of the handheld food, and in the second grip open position, the handheld food is slideable relative to the second grip.

15. The device of claim 14 wherein the program that causes the processor to command two opposing sides of the food handling mechanism to movingly cooperate to advance the handheld food first pivots the first grip from a first grip gripping location on the handheld food to the first grip open position and then rotates the second post to rotate and slide the handheld food first side relative to the first grip and then returns the first grip to the first grip gripping position to grip the handheld food at a different location than the first grip gripping location.

16. The device of claim 15 wherein the program that causes the processor to command two opposing sides of the food handling mechanism to movingly cooperate to advance the handheld food further comprises pivoting the second grip disposed at a second grip gripping location on the handheld food to the second grip open position after the first grip has been moved to the first grip gripping position at the different location, and then rotating the first post to rotate and slide the second side of the handheld food relative to the second grip and then returning the second grip to the second grip gripping position to grip the handheld food at a different second grip location than the second grip gripping location.
